(19) United States
(12) Patent Application Publication
(10) Pub. No.: US 2025/0168554 A1
(43) Pub. Date: May 22, 2025

(54) HEADPHONES

(71) Applicant: SHENZHEN SHOKZ CO., LTD., Shenzhen (CN)

(72) Inventors: Peigeng TONG, Shenzhen (CN); Shuailin XIE, Shenzhen (CN); Sifu ZHANG, Shenzhen (CN)

(73) Assignee: SHENZHEN SHOKZ CO., LTD., Shenzhen (CN)

(21) Appl. No.: 19/034,587

(22) Filed: Jan. 23, 2025

Related U.S. Application Data
(63) Continuation of application No. PCT/CN2023/126022, filed on Oct. 23, 2023.

(51) Int. Cl. H04R 1/10

(52) U.S. Cl. CPC H04R 1/1075; H04R 2460/13

(57) ABSTRACT

A headphone includes a housing including a bottom wall portion and a side wall portion connected with the bottom wall portion which cooperate to form an accommodation space, a sealing ring, a microphone assembly including a sound guiding member configured to hold the sealing ring against a microphone and a support surface provided on a side of the side wall portion facing the accommodation space, and a positioning member inserted between the housing and the sound guiding member to enable the sound guiding member to remain the sealing ring in a press-hold condition. The sealing ring encircling the sound guiding hole provided on the support surface for connecting the accommodation space and an exterior of the housing is provided on a support surface. A sound guiding channel is provided on the sound guiding member for guiding a sound input from the sound guiding hole to the microphone.

### CROSS-REFERENCE TO RELATED APPLICATIONS

This application is a Continuation of International Application No. PCT/CN2023/126022, filed on Oct. 23, 2023, the contents of which are hereby incorporated by reference.

### TECHNICAL FIELD

The present disclosure relates to the technical field of electronic devices, and in particular, to headphones.

### BACKGROUND

With the increasing popularity of electronic devices, electronic devices have become an indispensable social and entertainment tool in people's daily lives, and people's requirements for electronic devices are getting higher and higher. Electronic devices such as headphones and smart glasses have also been widely used in people's daily lives. They can be used with terminal devices such as mobile phones and computers to provide users with an auditory feast.

### SUMMARY

The present disclosure provides a headphone. The headphone may include a housing, a scaling ring, a microphone assembly, and a positioning member. The housing may include a bottom wall portion and a side wall portion connected with the bottom wall portion. The bottom wall portion and the side wall portion may cooperate to form an accommodation space. A support surface may be provided on a side of the side wall portion facing the accommodation space, and a sound guiding hole may be provided on the support surface for connecting the accommodation space and an exterior of the housing. The sealing ring may be provided on the support surface and encircling the sound guiding hole. The microphone assembly may include a sound guiding member and a microphone. The sound guiding member may be configured to hold the sealing ring against the support surface, and a sound guiding channel may be provided on the sound guiding member for guiding a sound input from the sound guiding hole to the microphone. The positioning member may be inserted between the housing and the sound guiding member to enable the sound guiding member to remain the sealing ring in a press-hold condition.

In some embodiments, one or more first positioning portions may be provided on the sound guiding member, and one or more second positioning portions may be provided on the housing. The one or more first positioning portions may be closer to the sealing ring than the one or more second positioning portions in a pressing direction of the sound guiding member against the sealing ring. The positioning member may be inserted between the one or more first positioning portions and the one or more second positioning portions.

In some embodiments, the positioning member may be capable of being inserted between the one or more first positioning portions and the one or more second positioning portions from a side of the sound guiding member back away from the bottom wall portion.

In some embodiments, a count of the one or more second positioning portions may be two. The two second positioning portions may be provided on two sides of the sound guiding member in a vertical direction perpendicular to the pressing direction. A middle region of the positioning member may abut the one or more first positioning portions, and two ends of the positioning member may abut the two second positioning portions, respectively.

In some embodiments, the sound guiding member may further include a main body portion. The main body portion may be supported on the bottom wall portion. The one or more first positioning portions may be located on a side of the main body portion back away from the bottom wall portion. The two second positioning portions may be located on two sides of the main body portion. The two ends of the positioning member may be bent relative to the middle region of the positioning member.

In some embodiments, the sound guiding member may further include a catch block. The catch block may be located on the side of the main body portion back away from the bottom wall portion and spaced apart from the one or more first positioning portions along the pressing direction to cooperate with each other to form a first catch slot. The middle region of the positioning member may be at least partially disposed within the first catch slot.

In some embodiments, in the vertical direction, a width of the catch block may be smaller than a width of the main body portion, a second catch slot may be provided in the middle region of the positioning member, and the catch block may be provided in the second catch slot.

In some embodiments, the microphone may be provided on a side of the main body portion facing the bottom wall portion, a side of the one or more first positioning portions may face the support surface presses the scaling ring, and the sound guiding channel may extend to the main body portion via the one or more first positioning portions and the catch block.

In some embodiments, the microphone assembly further may include a lead wire connected to the microphone, the side of the main body portion may face the bottom wall portion is further provided with a lead slot, and the lead wire may be provided within the lead slot.

In some embodiments, the housing may further include a guide portion disposed on the bottom wall portion, and the guide portion may be configured to guide the sound guiding member in the pressing direction.

In some embodiments, the guide portion may be provided such that the sound guiding member tends to move toward the support surface and the bottom wall portion simultaneously or move away from the support surface and the bottom wall portion simultaneously.

In some embodiments, the microphone assembly may further include a lead wire connected to the microphone. One end of the lead wire close to the microphone may be suspended relative to the bottom wall portion. The housing may further include a wire-bearing portion disposed on the bottom wall portion. The wire-bearing portion may be configured to support the lead wire and guide the lead wire toward the bottom wall portion.

In some embodiments, the housing may include one or more positioning portions. The one or more positioning portions may be provided on the bottom wall portion and/or the side wall portion, and the one or more positioning portions may abut the sound guiding member to allow the sound guiding member to remain the scaling ring in a press-hold condition.

In some embodiments, the one or more positioning portions may be integrally molded with the bottom wall portion and/or the side wall portion.

In some embodiments, in a pressing direction of the sound guiding member against the scaling ring, the sound guiding member may have a first end face facing the support surface and a second end face opposite to the first end face. The first end face may abut the sealing ring, and the one or more positioning portions may abut the second end face.

In some embodiments, the sound guiding member may be configured to be capable of being inserted and positioned between the support surface and the one or more positioning portions under an action of a pressing force toward the bottom wall portion.

In some embodiments, a side of the one or more positioning portions toward the support surface may have an abutting surface and a guiding surface connected with the abutting surface. The guiding surface may be configured to guide an end of the sound guiding member back away from the support surface to move to the abutting surface when the sound guiding member is subjected to the pressing force, which in turn causes the abutting surface to abut the second end face.

In some embodiments, the microphone may be provided on a side of the sound guiding member toward the bottom wall portion. The microphone assembly may further include a lead wire connected to the microphone. A lead slot may be further provided on the side of the sound guiding member toward the bottom wall portion. The lead wire may be provided in the lead slot.

In some embodiments, the sound guiding member may include two support portions spaced apart in a vertical direction perpendicular to the pressing direction and supported on the bottom wall portion. The lead slot may be disposed between the two support portions. The one or more positioning portions may be configured to abut a second end face of at least one of the two support portions and make the lead slot remain at least exposed on a side of the sound guiding member back from the support surface.

In some embodiments, one of the two support portions may be provided adjacent to the side wall portion, and the one or more positioning portions may be provided on the side wall portion.

In some embodiments, the housing may further include a guide portion disposed on the bottom wall portion, and the guide portion may be configured to guide the sound guiding member in the pressing direction.

In some embodiments, the microphone assembly may further include a lead wire connected to the microphone. One end of the lead wire close to the microphone may be suspended relative to the bottom wall portion. The housing may further include a wire-bearing portion disposed on the bottom wall portion. The wire-bearing portion may be configured to support the lead wire and guide the lead wire toward the bottom wall portion.

### BRIEF DESCRIPTION OF THE DRAWINGS

To more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings.

FIG. 1 is a schematic diagram illustrating a three-dimensional structure of a headphone according to some embodiments of the present disclosure;

FIG. 2 is a schematic diagram illustrating a part of the structure of the headphone shown in FIG. 1;

FIG. 3 is a schematic diagram illustrating a disassembled structure of the part of the structure of the headphone shown in FIG. 2;

FIG. 4 is a schematic diagram illustrating a three-dimensional structure of a sound guiding member shown in FIG. 3;

FIG. 5 is a sectional structure of the headphone shown in FIG. 2 along a P-P sectional direction;

FIG. 6 is a schematic diagram illustrating another disassembled structure of the part of the structure of the headphone shown in FIG. 2;

FIG. 7 is a schematic diagram illustrating another part of the structure of the headphone shown in FIG. 1;

FIG. 8 is a schematic diagram illustrating a disassembled structure of the part of the structure of the headphone shown in FIG. 6; and

FIG. 9 is a sectional structure of the headphone shown in FIG. 6 along a G-G sectional direction.

### DETAILED DESCRIPTION

The technical solutions in the embodiments of the present disclosure will be clearly and completely described below in conjunction with the accompanying drawings in the embodiments of the present disclosure. It is clear that the described embodiments are only a part of the embodiments of the present disclosure, and not all of the embodiments. Based on the embodiments in the present disclosure, all other embodiments obtained by a person of ordinary skill in the art without making creative labor fall within the scope of protection of the present disclosure.

References to “embodiments” in the present disclosure mean that particular features, structures, or characteristics described in conjunction with embodiments may be included in at least one embodiment of the present disclosure. It is understood by those of skill in the art, both explicitly and implicitly, that the embodiments described in the present disclosure may be combined with other embodiments.

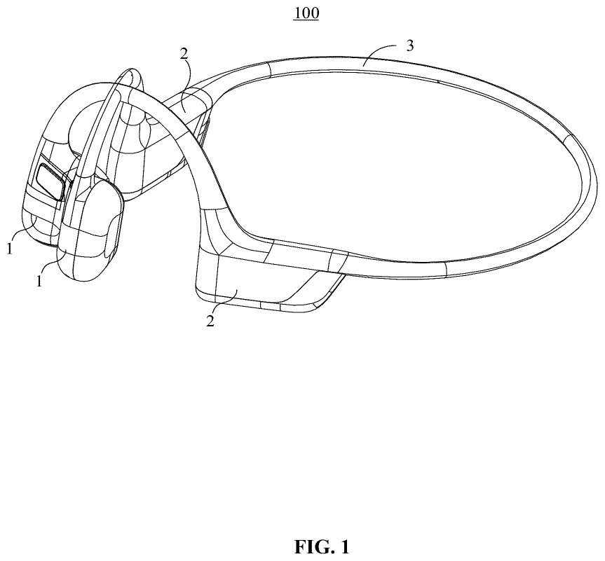

The present disclosure provides a headphone 100, as shown in FIG. 1, which is a general assembly diagram of the headphone 100 of the present disclosure. The headphone 100 includes a movement assembly 1, an ear hook 2 and a rear hook 3. In this embodiment, the number of the movement assembly 1 is two, and the two movement assemblies 1 are configured to transmit vibration and/or sound to the left and right cars of a user, respectively, and the two movement assemblies 1 may be the same or different. For example, one of the two movement assemblies 1 may be provided with a microphone, and the other one of the two movement assemblies 1 may not be provided with a microphone. For example, one of the two movement assemblies 1 may be provided with a key and a corresponding circuit board, and the other one of the two movement assemblies 1 may not be provided with the key and the corresponding circuit board. Movement modules (e.g., a loudspeaker module) of the two movement assemblies 1 may be identical. The number of the ear hook 2 may be two, and the two ear hooks 2 may be located in the left and right cars of the user, respectively, so as to allow the movement assemblies 1 to fit the face of the user. One ear hook 2 may be provided with a battery, and the other ear hook 2 may be provided with a control circuit, or the like. One end of the ear hook 2 is connected to the movement assembly 1, and the other end of the ear hook 2 is connected to the rear hook 3. The rear hook 3 connects the two ear hangers 2, and the rear hook 3 is configured to wrap around the back of the neck or the back of the brain of the user, and may provide a clamping force to make the two movement assemblies 1 clamped to both sides of the face of the user and the ear hooks 2 hang more firmly on the cars of the user.

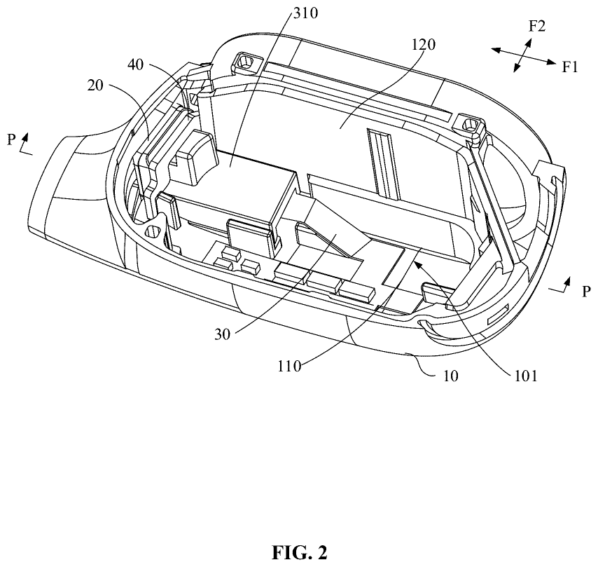

In some embodiments, as shown in FIG. 2, the headphone 100 of the embodiments of the present disclosure includes a housing 10, a sealing ring 20, a microphone assembly 30, and a positioning member 40. Optionally, the movement assembly 1 includes the housing 10, the scaling ring 20, the microphone assembly 30, and the positioning member 40.

Optionally, as shown in FIG. 2 to FIG. 5, the housing 10 includes a bottom wall portion 110 and a side wall portion 120 connected with the bottom wall portion 110. The bottom wall portion 110 and the side wall portion 120 cooperates to form an accommodation space 101, and a support surface 102 is provided on a side of the side wall portion 120 toward the accommodation space 101. A sound guiding hole 103 is provided on the support surface 102 for connecting the accommodation space 101 and an exterior of the housing 10. The sealing ring 20 is provided on the support surface 102 and surrounds the sound guiding hole 103. The microphone assembly 30 includes a sound guiding member 310 and a microphone 320. The sound guiding member 310 is configured to hold the sealing ring 20 against the support surface 102, and a sound guiding channel 301 is provided on the sound guiding member 310 for guiding a sound input from the sound guiding hole 103 to the microphone 320. The positioning member 40 is inserted between the housing 10 and the sound guiding member 310 to enable the sound guiding member 310 to remain the scaling ring 20 in a press-hold condition. The number of the sound guiding hole 103 may be one or two. For example, two sound guiding holes 103 are provided side-by-side on the support surface 102. Certainly, the number of the sound guiding hole 103 may also be three, four, five, etc.

By providing the scaling ring 20 surrounding the sound guiding hole 103, the sealing ring 20 is disposed between the support surface 102 and the sound guiding member 310, and the sound guiding member 310 is provided with a sound guiding channel 301 that conducts the sound input from the sound guiding hole 103 to the microphone 320 to achieve good conduction of sound, which is conducive to enhancing the quality of the transmitted sound. In addition, by setting the positioning member 40 and inserting it between the housing 10 and the sound guiding member 310 to remain the sealing ring 20 in a press-hold condition, the effect of pressing the scaling ring 20 by the sound guiding member 310 is effectively improved, thereby improving the scaling effect of the sealing ring 20 to realize good sound conduction, which is conducive to improving the usage of the headphone 100.

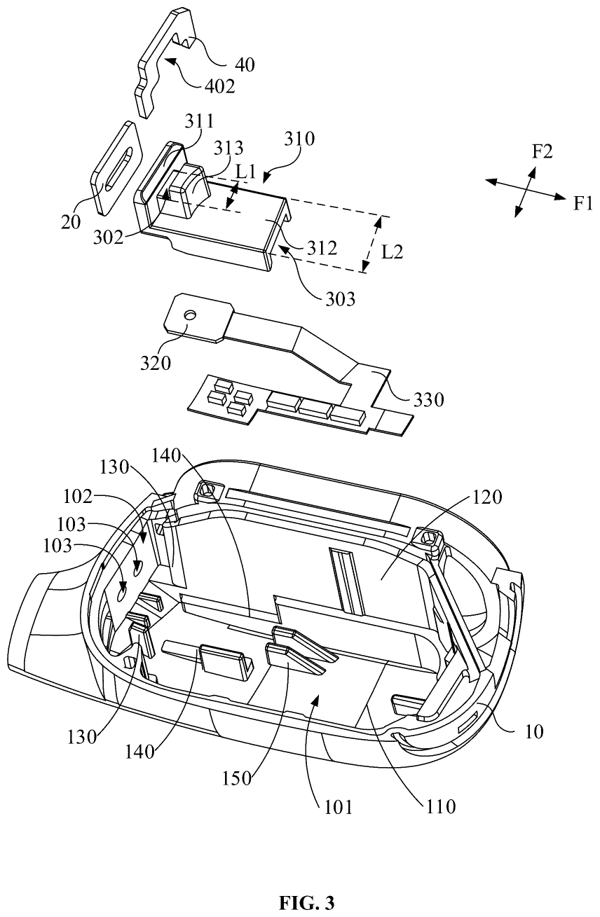

Optionally, as shown in FIG. 3, the first positioning portion 311 is provided on the sound guiding member 310, and the second positioning portion 130 is provided on the housing 10. In the pressing direction F1 of the sound guiding member 310 against the sealing ring 20, the first positioning portion 311 is closer to the sealing ring 20 than the second positioning portion 130, and the positioning member 40 is inserted between the first positioning portion 311 and the second positioning portion 130.

By providing the first positioning portion 311 and the second positioning portion 130, it is convenient to locate and install the positioning member 40, and the positioning member 40 is capable of continuously exerting pressure on the first positioning portion 311 under the restriction of the second positioning portion 130, thus the sound guiding member 310 remains the scaling ring 20 on the press-hold condition, which is conducive to enhancing the sealing effect of the sealing ring 20, thus improving the usage of the headphone 100.

Optionally, as shown in FIG. 2 and FIG. 3, the positioning member 40 is provided to be capable of being inserted between the first positioning portion 311 and the second positioning portion 130 from a side of the sound guiding member 310 back away from the bottom wall portion 110.

By setting the positioning member 40 to be inserted between the first locating portion 311 and the second locating portion 130 from the side of the sound guiding member 310 back away from the bottom wall portion 110, the sealing ring 20 may be free from an excessive pressing holding force when the positioning member 40 is not provided, to ensure the scaling ring 20 not be deformed due to the additional pressing holding force when the sealing ring 20 is provided, such as when wrinkles or gaps occur on the support surface 102, effectively improving the sealing effect of the sealing ring 20, which is conducive to reducing the difficulty of assembling the scaling ring 20 and is conducive to improving the efficiency of assembling the scaling ring 20 and effectively improving the yield rate of the headphone 100.

Optionally, as shown in FIG. 3, the number of the second positioning portions 130 is two, the two second positioning portions 130 are disposed on two sides of the sound guiding member 310 in a vertical direction F2 perpendicular to the pressing direction F1. A middle region of the positioning member 40 abuts the first positioning portion 311, and two ends of the positioning member 40 abut two second positioning portions 130, respectively.

By providing two second positioning portions 130, it is easy to locate and install the positioning member 40, and the two second positioning portions 130 abut the two ends of the positioning member 40, respectively, which is conducive to realizing the balance of force on the two sides of the positioning member 40 and is conducive to enhancing the service life and usage of the headphone 100.

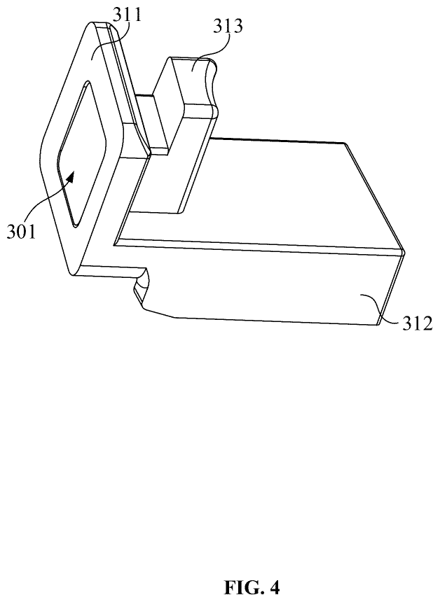

Optionally, as shown in FIG. 3 and FIG. 4, the sound guiding member 310 further includes a main body portion 312. The main body portion 312 is supported on the bottom wall portion 110, the first positioning portion 311 is located on a side of the main body portion 312 back away from the bottom wall portion 110. Two second positioning portions 130 are located on two sides of the positioning member 40, and the two ends of the positioning member 130 are bent relative to the middle of the positioning member 40.

By bending the two ends of the positioning member 40 relative to the middle region of the positioning member 40 to realize that the two second positioning portions 130 abut the two ends of the positioning member 40 and the middle region of the positioning member 40 abuts the first positioning portion 311, making the headphone 100 have a more compact structure inside the headphone 100, improving the integration and tightness of the structure, which is conducive to enhancing the space utilization inside the headphone 100. In addition, the two ends of the positioning member 40 is bent relative to the middle region of the positioning member 40, which may enhance the strength of the positioning member 40, reduce the possibility of damage to the positioning member 40, and thus enhance the service life of the headphone.

Optionally, as shown in FIG. 3 and FIG. 4, the sound guiding member 310 further includes a catch block 313, the catch block 313 being located on the side of the main body portion 312 back away from the bottom wall portion 110 and spaced apart from the first positioning portion 311 along the pressing direction F1 to cooperate with each other to form the first catch slot 302. The middle region of the positioning member 40 is at least partially disposed within the first catch slot 302.

By setting the catch block 313 to cooperate with the first positioning portion 311 to form the first catch slot 302, it is convenient for the positioning member 40 to be provided and fixed, which is conducive to reducing the difficulty of assembling the headphone 100 and is conducive to improving the assembly efficiency and the yield rate of the headphone 100.

Optionally, as shown in FIG. 3, in the vertical direction F2, the width L1 of the catch block 313 is smaller than the width L2 of the main body portion 312. The middle region of the positioning member 40 is provided with a second catch slot 402, and the catch block 313 is provided in the second catch slot 402.

By setting the width L1 of the catch block 313 to be smaller than the width L2 of the main body portion 312 in the vertical direction F2 and setting the second catch slot 402 in the middle region of the positioning member 40, it is easy to locate and install the positioning member 40, which is conducive to lowering the assembly difficulty of the headphone 100, and improving the assembly efficiency and yield rate. Additionally, the first catch slot 302 and the second catch slot 402 are provided simultaneously to enable double positioning of the assembly of the positioning member 40, which effectively improves the positioning effect and enhances the accuracy of the assembly.

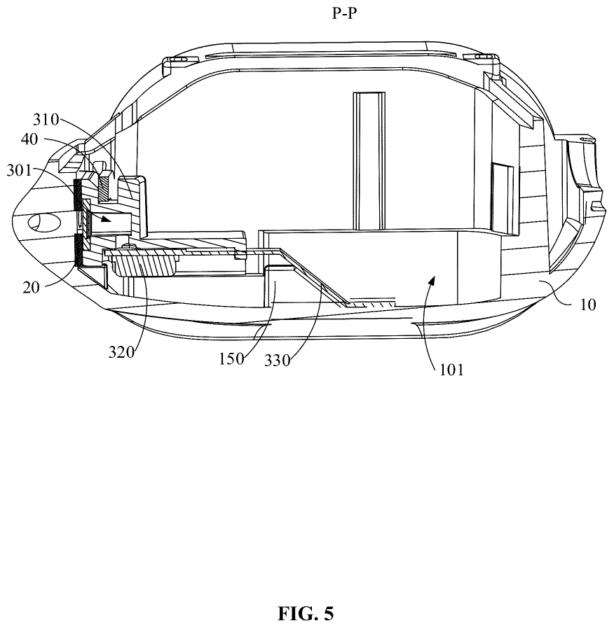

Optionally, as shown in FIG. 3 and FIG. 5, the microphone 320 is provided on the side of the main body portion 312 toward the bottom wall portion 110, the side of the first positioning portion 311 toward the support surface 102 press the scaling ring 20, and the sound guiding channel 301 extends to the main body portion 312 via the first positioning portion 311 and the catch block 313. In this way, the sound may be transmitted from the sound guiding channel 301 to the microphone 320, effectively guaranteeing the sound transmission effect and making the internal structure of the headphone 100 more compact, improving the integration and tightness of the structure, which is conducive to improving the space utilization rate inside the headphone 100.

Optionally, as shown in FIG. 3, the microphone assembly 30 further includes a lead wire 330 connected to the microphone 320, and the side of the main body portion 312 facing the bottom wall portion 110 is further provided with a lead slot 303. The lead wire 330 is provided within the lead slot 303.

By providing the lead slot 303 to accommodate the lead wire 330, it is convenient to protect the lead wire 330, reduce the possibility that the lead wire 330 receives interference, and make the structure inside the headphone 100 more compact and improve the integration and tightness of the structure, which is conducive to improving the space utilization rate inside the headphone 100.

Optionally, as shown in FIG. 3, the housing 10 further includes a guide portion 140 disposed on the bottom wall portion 110, and the guide portion 140 is configured to guide the sound guiding member 310 along the pressing direction F1.

By providing the guide portion 140 on the bottom wall portion 110, it is easy to position and install the sound guiding member 310, reduce the difficulty of assembling the sound guiding member 310, and effectively guarantee that the sound guiding member 310 presses the scaling ring 20 along the pressing direction F1, thereby improving the sealing effect of the scaling ring 20.

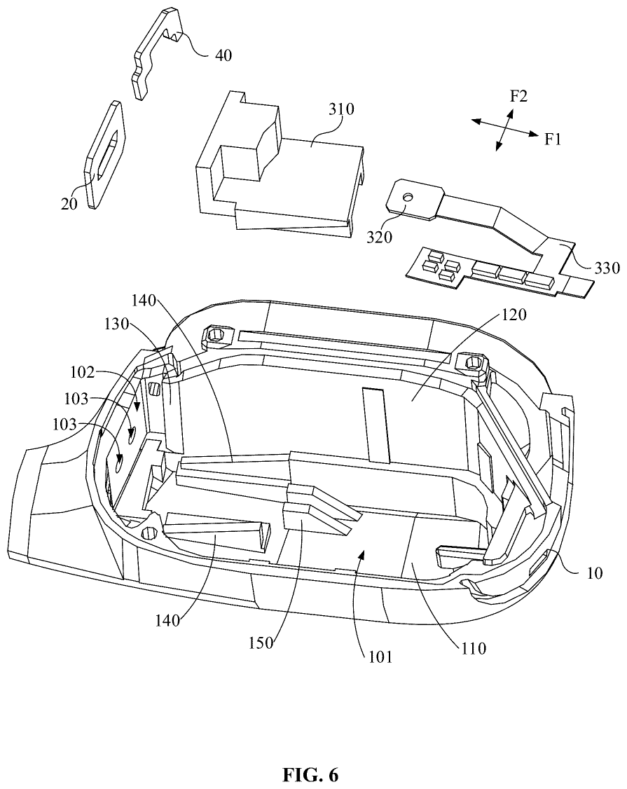

Optionally, as shown in FIG. 6, the guide portion 140 is provided such that the sound guiding member 310 tends to move toward the support surface 102 and the bottom wall portion 110 simultaneously or move away from the support surface 102 and the bottom wall portion 110 simultaneously. Such a setting facilitates the positioning and installation of the sound guiding member 310, which is conducive to reducing the difficulty of assembling the sound guiding member 310, and further improves the pressing effect of the sound guiding member 310 on the scaling ring 20, which in turn improves the sealing effect of the sealing ring 20.

Optionally, as shown in FIG. 3 and FIG. 5, the microphone assembly 30 further includes a lead wire 330 connected to the microphone 320. One end of the lead wire 330 close to the microphone 320 is suspended relative to the bottom wall portion 110. The housing 10 further includes a wire-bearing portion 150 disposed on the bottom wall portion 110. The wire-bearing portion 150 is configured to support the lead wire 330 and guide the lead wire 330 toward the bottom wall portion 110.

By providing the wire-bearing portion 150 to support the lead wire 330 and guide the lead wire 330 toward the bottom wall portion 110, it is conducive to reducing the probability of the lead wire 330 being subjected to external interference, such as shaking, etc., and is conducive to enhancing the stability and reliability of the operation of the lead wire 330.

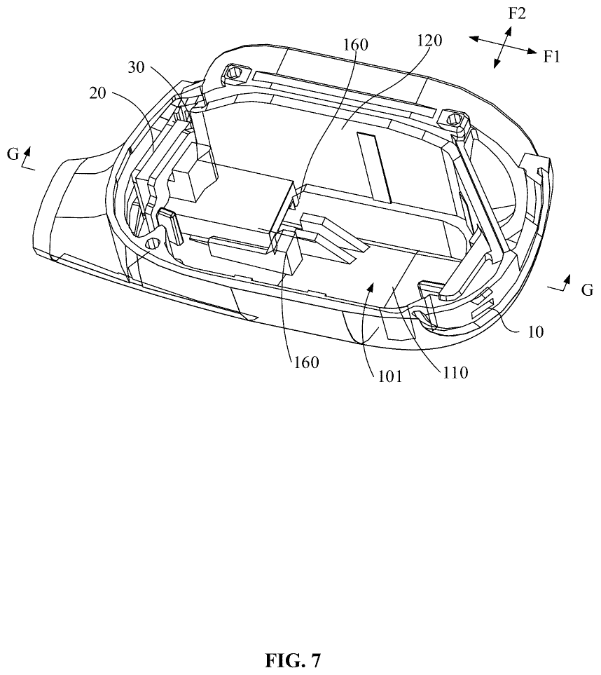

In some embodiments, as shown in FIG. 7, the headphone 100 of the embodiments of the present disclosure includes the housing 10, the sealing ring 20, and the microphone assembly 30. Optionally, the movement assembly 1 includes the housing 10, the sealing ring 20, and the microphone assembly 30.

Optionally, as shown in FIG. 7 to FIG. 9, the housing 10 includes a bottom wall portion 110, a side wall portion 120 connected with the bottom wall portion 110, and a positioning portion 160. The bottom wall portion 110 and the side wall portion 120 cooperates to form an accommodation space 101, the side wall portion 120 is provided with a support surface 102 on a side facing the accommodation space 101, the support surface 102 is provided with a sound guiding hole 103 for connecting the accommodation space 101 and the exterior of the housing 10, and the positioning portion 160 is provided on the bottom wall portion 110 and/or the side wall portion 120. The scaling ring 20 is provided on the support surface 102 and encircles the sound guiding hole 103. The microphone assembly 30 includes a sound guiding member 310 and a microphone 320. The sound guiding member 310 is configured to hold the scaling ring 20 against the support surface 102, and a sound guiding channel 301 is provided on the sound guiding member 310 for guiding the sound input from the sound guiding hole 103 to the microphone 320. The positioning portion 160 abuts the sound guiding member 310 to allow the sound guiding member 310 to remain pressed against the scaling ring 20. The number of the sound guiding hole 103 may be, for example, one, or two. For example, two sound guiding holes 103 are provided side-by-side on the support surface 102, and certainly the number of the sound guiding hole 103 may also be three, four, five, etc.

By providing the sealing ring 20 encircling the sound guiding hole 103, the scaling ring 20 is located between the support surface 102 and the sound guiding member 310, and the sound guiding member 310 is provided with a sound guiding channel 301 that conducts the sound input from the sound guiding hole 103 to the microphone 320 to achieve good conduction of sound, which is conducive to enhancing the quality of the transmitted sound. In addition, by providing the positioning portion 160 to abut the sound guiding member 310, the sound guiding member 310 remains the sealing ring 20 in a press-hold condition. The sealing effect of the sealing ring 20 is effectively improved, and the assembly difficulty is reduced, which is conducive to improving the assembly efficiency and the yield rate.

Optionally, the positioning portion 160 is integrally molded with the bottom wall portion 110 and/or the side wall portion 120. By integrally molding the positioning portion 160, the accurate setting of the positioning portion 160 may be realized and the effect of the positioning portion 160 against the sound guiding member 310 may be improved, thus improving the usage of the headphone 100.

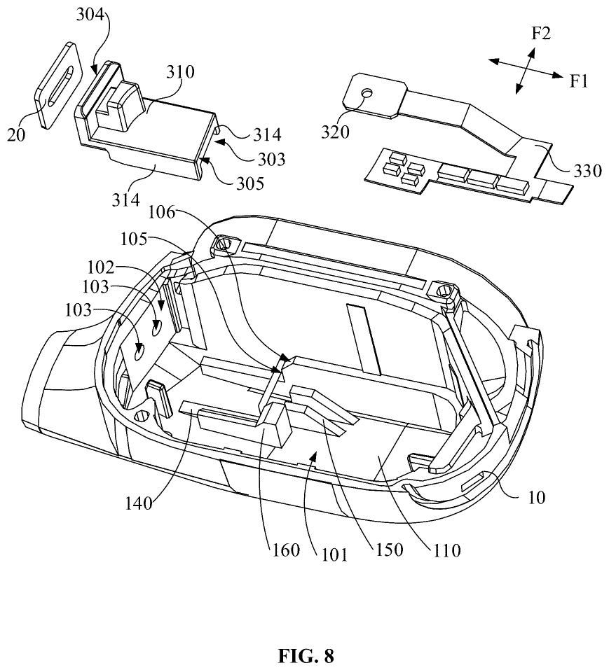

Optionally, as shown in FIG. 8, in the pressing direction F1 of the sound guiding member 310 against the sealing ring 20, the sound guiding member 310 has a first end face 304 facing the support surface 102, and a second end face 305 opposite to the first end face 304. The first end face 304 abuts the sealing ring 20, and the positioning portion 160 abuts the second end face 305.

By providing the first end surface 304 and the second end surface 305 that respectively abuts the scaling ring 20 and the positioning portion 160, it is possible to realize that the positioning portion 160 abuts the sound guiding member 310, which in turn abuts the scaling ring 20. With a simple and effective, it is conducive to improving the integration and tightness of the structure and is conducive to improving the space utilization of the headphone 100.

Optionally, as shown in FIG. 7 and FIG. 8, the sound guiding member 310 is configured to be capable of being inserted and positioned between the support surface 102 and the positioning portion 160 under the action of the pressing force toward the bottom wall portion 110. Such a setting is capable of simplifying the assembly steps and reducing the difficulty of assembly while realizing the pressing force of the sound guiding member 310 on the sealing ring 20, thereby enhancing the assembly efficiency.

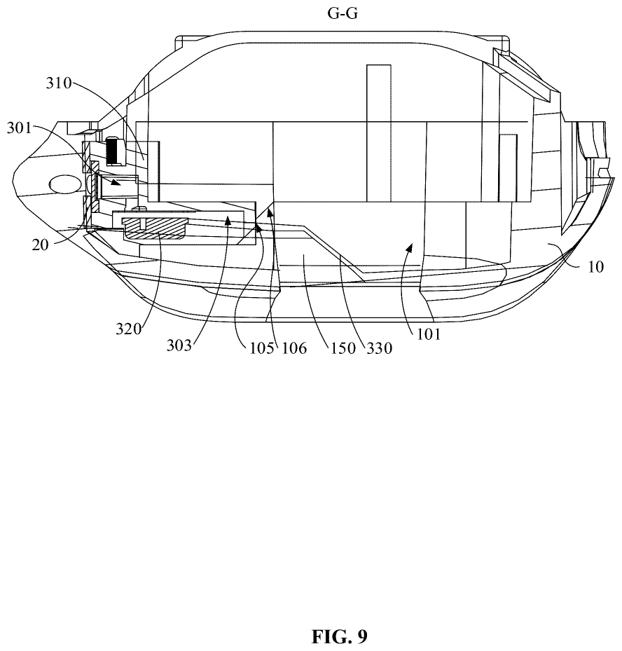

Optionally, as shown in FIG. 8 and FIG. 9, the side of the positioning portion 160 facing the support surface 102 has an abutting surface 105 and a guiding surface connected with the abutting surface. The guiding surface is configured to guide an end of the sound guiding member 310 back away from the support surface 102 to move to the abutting surface 105 when the sound guiding member 310 is subjected to pressing pressure, thereby causing the abutting surface 105 to abut the second end surface 305.

By setting the abutting surface 105 and the guiding surface 106 connected to each other to realize that the guiding surface 106 guides the sound guiding member 310 to be positioned and mounted, and the abutting surface 105 in turn abuts against the second end surface 305 to realize that the sound guiding member 310 abuts the sealing ring 20, the assembly process of the sound guiding member 310 is clear and smooth. While ensuring the sealing effect of the sealing ring 20, it is conducive to reducing the difficulty of assembling the headphone 100 and improving the assembly efficiency of the headphone 100.

Optionally, as shown in FIG. 8 and FIG. 9, the microphone 320 is provided on the side of the sound guiding member 310 facing the bottom wall portion 110. The microphone assembly 30 further includes a lead wire 330 connected to the microphone 320. The side of the sound guiding member 310 facing the bottom wall portion 110 is further provided with a lead slot 303, and the lead wire 330 is provided within the lead slot 303.

By providing the lead slot 303 to accommodate the lead wire 330, it is convenient to protect the lead wire 330, reduce the possibility of the lead wire 330 being interfered with, and make the structure inside the headphone 100 more compact, which improves the integration and tightness of the structure and is conducive to improving the space utilization rate inside the headphone 100.

Optionally, as shown in FIG. 8, the sound guiding member 310 includes two support portions 314 spaced apart along the vertical direction F2 perpendicular to the pressing direction F1 and supported on the bottom wall portion 110. The lead slot 303 is disposed between the two support portions 314. The positioning portion 160 is configured to abut a second end surface 305 of at least one of two support portions 314 and make the lead slot 303 remain at least exposed on the side of the sound guiding member 310 back from the support surface 102.

By providing the support portion 314 to make the positioning portion 160 abut the sound guiding member 310 and the lead slot 303 is located between the two support portions 314, the effect of the sound guiding member 310 pressing on the scaling ring 20 is ensured, and at the same time, the structural integration and tightness is improved, which is conducive to enhancing the utilization of space inside the headphone 100.

Optionally, as shown in FIG. 7 and FIG. 8, one of the two support portions 314 is provided adjacent to the side wall portion 120, and the positioning portion 160 is provided on the side wall portion 120. Set up in such a manner, it is possible to make the positioning portion 160 to abut the support portion 314, and thus to make the positioning portion 160 abut the sound guiding member 310. The structure is simple and effective, and it is conducive to enhancing the integrality and tightness of the structure, which is conducive to enhancing the utilization of space inside the headphone 100.

Optionally, as shown in FIG. 8, the housing 10 further includes a guide portion 140 disposed on the bottom wall portion 110, and the guide portion 140 is configured to guide the sound guiding member 310 in the pressing direction F1.

By providing the guide portion 140 on the bottom wall portion 110, it is easy to position and install the sound guiding member 310, reduce the difficulty of assembling the sound guiding member 310, and effectively ensure that the sound guiding member 310 presses the scaling ring along the pressing direction F1, thus improving the sealing effect of the scaling ring.

Optionally, as shown in FIG. 8 and FIG. 9, the microphone assembly 30 further includes the lead wire 330 connected to the microphone 320, the end of the lead wire 330 close to the microphone 320 is suspended relative to the bottom wall portion 110. The housing 10 further includes a wire-bearing portion 150 disposed on the bottom wall portion 110, the wire-bearing portion 150 is configured to support the lead wire 330 and guide the lead wire 330 toward the bottom wall portion 110.

By providing the wire-bearing portion 150 to support the lead wire 330 and guide the lead wire 330 toward the bottom wall portion 110, it is conducive to reducing the probability of the lead wire 330 being subjected to external interference, such as shaking, etc., and is conducive to enhancing the stability and reliability of the operation of the lead wire 330.

The foregoing is only an example of the embodiments of the present disclosure, and is not intended to limit the scope of the patent of the present disclosure. Any equivalent structure or equivalent process transformations utilizing the contents of the present disclosure and the accompanying drawings, or applying them directly or indirectly in other related fields of technology, are all the equivalent structure or equivalent process transformations utilizing the contents of the present disclosure and the accompanying drawings, or directly or indirectly applied in other related technical fields, are included in the scope of patent protection of the present disclosure.

1. A headphone, comprising:
a housing including a bottom wall portion and a side wall portion connected with the bottom wall portion, wherein the bottom wall portion and the side wall portion cooperate to form an accommodation space, a support surface is provided on a side of the side wall portion facing the accommodation space, and a sound guiding hole is provided on the support surface for connecting the accommodation space and an exterior of the housing;
a sealing ring provided on the support surface and encircling the sound guiding hole;
a microphone assembly, wherein the microphone assembly includes a sound guiding member and a microphone, the sound guiding member is configured to hold the sealing ring against the support surface, and a sound guiding channel is provided on the sound guiding member for guiding a sound input from the sound guiding hole to the microphone; and
a positioning member, wherein the positioning member is inserted between the housing and the sound guiding member to enable the sound guiding member to remain the sealing ring in a press-hold condition.

2. The headphone of claim 1, wherein
one or more first positioning portions are provided on the sound guiding member,
one or more second positioning portions are provided on the housing,
the one or more first positioning portions are closer to the sealing ring than the one or more second positioning portions in a pressing direction of the sound guiding member against the sealing ring, and
the positioning member is inserted between the one or more first positioning portions and the one or more second positioning portions.

3. The headphone of claim 2, wherein
the positioning member is capable of being inserted between the one or more first positioning portions and the one or more second positioning portions from a side of the sound guiding member back away from the bottom wall portion.

4. The headphone of claim 3, wherein
a count of the one or more second positioning portions is two,
the two second positioning portions are provided on two sides of the sound guiding member in a vertical direction perpendicular to the pressing direction,
a middle region of the positioning member abuts the one or more first positioning portions, and
two ends of the positioning member abut the two second positioning portions, respectively.

5. The headphone of claim 4, wherein
the sound guiding member further includes a main body portion,
the main body portion is supported on the bottom wall portion,
the one or more first positioning portions are located on a side of the main body portion back away from the bottom wall portion,
the two second positioning portions are located on two sides of the main body portion, and
the two ends of the positioning member are bent relative to the middle region of the positioning member.

6. The headphone of claim 5, wherein
the sound guiding member further includes a catch block,
the catch block is located on the side of the main body portion back away from the bottom wall portion and spaced apart from the one or more first positioning portions along the pressing direction to cooperate with each other to form a first catch slot, and
the middle region of the positioning member is at least partially disposed within the first catch slot.

7. The headphone of claim 6, wherein
in the vertical direction, a width of the catch block is smaller than a width of the main body portion,
a second catch slot is provided in the middle region of the positioning member, and
the catch block is provided in the second catch slot.

8. The headphone of claim 6, wherein
the microphone is provided on a side of the main body portion facing the bottom wall portion,
a side of the one or more first positioning portions facing the support surface presses the sealing ring, and
the sound guiding channel extends to the main body portion via the one or more first positioning portions and the catch block.

9. The headphone of claim 8, wherein
the microphone assembly further includes a lead wire connected to the microphone,
the side of the main body portion facing the bottom wall portion is further provided with a lead slot, and
the lead wire is provided within the lead slot.

10. The headphone of claim 5, wherein
the housing further includes a guide portion disposed on the bottom wall portion, and
the guide portion is configured to guide the sound guiding member in the pressing direction.

11. The headphone of claim 10, wherein
the guide portion is provided such that the sound guiding member tends to move toward the support surface and the bottom wall portion simultaneously or move away from the support surface and the bottom wall portion simultaneously.

12. The headphone of claim 1, wherein
the microphone assembly further includes a lead wire connected to the microphone,
one end of the lead wire close to the microphone is suspended relative to the bottom wall portion,
the housing further includes a wire-bearing portion disposed on the bottom wall portion, and
the wire-bearing portion is configured to support the lead wire and guide the lead wire toward the bottom wall portion; and
the microphone assembly further includes a lead wire connected to the microphone,
one end of the lead wire close to the microphone is suspended relative to the bottom wall portion,
the housing further includes a wire-bearing portion disposed on the bottom wall portion, and
the wire-bearing portion is configured to support the lead wire and guide the lead wire toward the bottom wall portion.

13. The headphone of claim 1, wherein
the housing includes one or more positioning portions,
the one or more positioning portions are provided on the bottom wall portion and/or the side wall portion, and
the one or more positioning portions abut the sound guiding member to allow the sound guiding member to remain the sealing ring in a press-hold condition.

14. (canceled)

15. The headphone of claim 13, wherein
in a pressing direction of the sound guiding member against the sealing ring, the sound guiding member has a first end face facing the support surface and a second end face opposite to the first end face,
the first end face abuts the sealing ring, and
the one or more positioning portions abut the second end face.

16. The headphone of claim 15, wherein
the sound guiding member is configured to be capable of being inserted and positioned between the support surface and the one or more positioning portions under an action of a pressing force toward the bottom wall portion.

17. The headphone of claim 16, wherein
a side of the one or more positioning portions toward the support surface has an abutting surface and a guiding surface connected with the abutting surface,
the guiding surface is configured to guide an end of the sound guiding member back away from the support surface to move to the abutting surface when the sound guiding member is subjected to the pressing force, which in turn causes the abutting surface to abut the second end face.

18. The headphone of claim 15, wherein
the microphone is provided on a side of the sound guiding member toward the bottom wall portion,
the microphone assembly further includes a lead wire connected to the microphone,
a lead slot is further provided on the side of the sound guiding member toward the bottom wall portion, and
the lead wire is provided in the lead slot.

19. The headphone of claim 18, wherein
the sound guiding member includes two support portions spaced apart in a vertical direction perpendicular to the pressing direction and supported on the bottom wall portion,
the lead slot is disposed between the two support portions,
the one or more positioning portions are configured to abut a second end face of at least one of the two support portions and make the lead slot remain at least exposed on a side of the sound guiding member back from the support surface.

20. The headphone of claim 19, wherein
one of the two support portions is provided adjacent to the side wall portion, and
the one or more positioning portions are provided on the side wall portion.

21. The headphone of claim 15, wherein
the housing further includes a guide portion disposed on the bottom wall portion, and
the guide portion is configured to guide the sound guiding member in the pressing direction.

22. (canceled)
